(19) United States
(12) Patent Application Publication
(10) Pub. No.: US 2010/0014650 A1
(43) Pub. Date: Jan. 21, 2010

(54) Digital fax using analog lines

(76) Inventor: Scott C. Harris, Rancho Santa Fe, CA (US)

Correspondence Address: SCOTT C HARRIS, P O BOX 927649, SAN DIEGO, CA, 92192, US

(21) Appl. No.: 12/174,788

(22) Filed: Jul. 17, 2008

(51) Int. Cl. H04M 11/00

(52) U.S. Cl. 379/100.17

(57) ABSTRACT

A digital fax system carries out handshaking over the voice lines as conventional and sends the scanned document by electronic communication, e.g. email, to a recipient.

Fax machines use an analog phone line to communicate between one fax connected to that analog phone line, and another fax connected to that analog phone line. Fax machines may use modem technology to send the information encoded as sounds over the analog phone line. In this way, anyone with access to a phone line that allows voice communication can send and receive faxes. This is a relatively simplistic system that has maintained its popularity over time due to the fact that phone lines are ubiquitous.

Different levels of faxing are possible over the phone line, such as group 2 and group 3. The data handling capability of the analog phone line limits the amount and speed of fax communication that can take place over a phone line.

Higher levels of fax communication, such as group 4, have not found wide popularity, due to their need for special phone line types.

### SUMMARY

Embodiments describe fax machines where the handshaking operation between the fax machines is carried out over the analog phone line and the actual data communication is carried out digitally over a network connection.

### BRIEF DESCRIPTION OF THE DRAWINGS

In the drawings:

FIG. 1 shows an embodiment;

### DETAILED DESCRIPTION

The present inventor recognized that many fax machines have other kinds of capabilities. Fax machines may also have scanning capabilities, network capabilities, the ability to print via a USB port, and others. For example, some fax machines are network fax machines which receive faxes and digitize the content of those faxes and send the digitized faxes as messages over a network.

The inventor recognizes that weak link in this system is the faxes being communicated over the legacy analog phone lines. Fax systems that are not compatible with the existing faxes from working properly have no found wide acceptance. The inventor believes that no one is willing to break the deadlock created by the installed base of existing fax machines. People often scan and send documents, e.g, word documents or PDFs for example, by e-mail as a digital alternative to faxes. faxes are easier in many ways, since you only need a telephone number in order to send the fax.

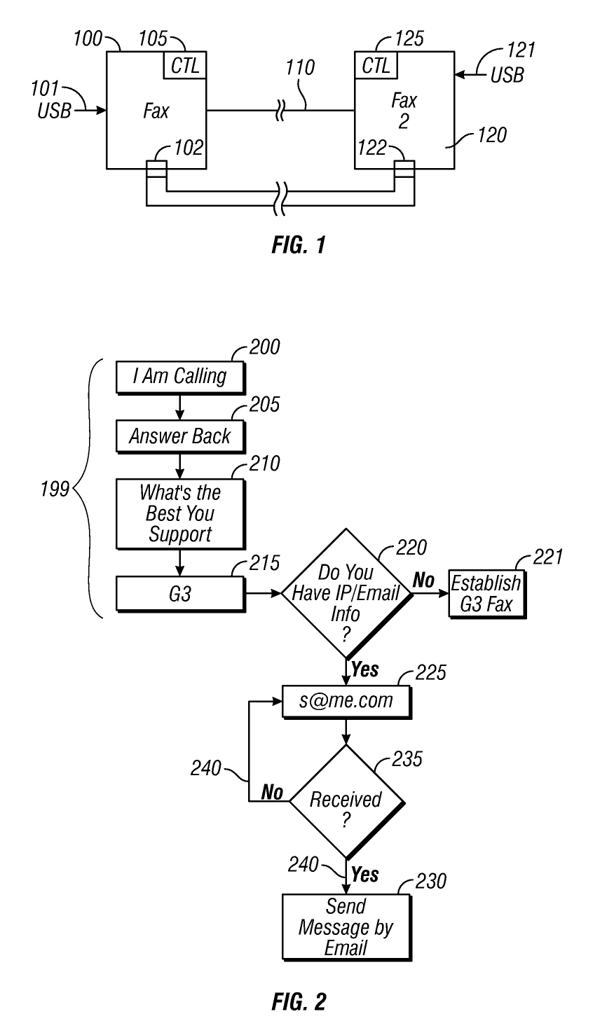

An embodiment which addresses this issue is shown in FIG. 1. fax machine 100 is connected to a phone line 110 as conventional, and to a remote fax machine, shown as 120. The fax machines and phone lines 110 can extend anywhere in the world. The fax machines 100 and 120 have additional features. For example, they may have USB connectors shown as 101, 121 respectively. The fax machines are also connected to a network.

A fax machine 100 has a network connection 102, and the fax machine 120 has a network connection 122. These network connections are eventually connected to the Internet. The faxes are controlled according to a controller 105, 125. The controllers control carrying out handshaking over the phone line 110. The fax machine may have a scanner for documents, a user interface with a dial pad to dial a phone number of a remote fax machine, and a printer for received faxes as conventional.

The handshaking uses a protocol for the faxes to exchange information so that the machines can determine how to best send faxes. Handshaking has been used so that different fax machines can discover that the other fax machine speaks the same fax language, e.g., the same group. FIG. 2 illustrates a handshaking sequence according to the improved fax machine in FIG. 1. The handshaking can be carried out using analog tones over a telephone line. A first handshake 200 may simply be an introductory handshake, indicating that a fax is calling at 200. The remote fax 120 answers, and sends back an answerback tone 205 that simply indicates it is a fax machine. At 210, the originating fax sends a conventional series of tones to indicate or determine what the most advanced group that the fax machine supports. The remote fax may indicate “the best I support is group 3” at 215, for example. Up until now, these handshaking steps 199 are wholly conventional, and would establish a group 3 fax.

In the embodiment, the originating fax machine also sends another request at 220, which in essence asks, again over the analog fax line, “do you have e-mail capability?”.

A legacy fax machine which does not have this advanced fax capability will not understand this request, and will simply not answer. Accordingly, at this point, a group III fax communication is established at 221. However, if the answer is yes, the system may return an e-mail address such as y@es.com, which may be a mailbox associated with the fax machine. This may be entered into the fax machine. Alternatively the fax machine may automatically detect its own IP/mail address by querying the system on startup. It may then find the IP address of the gateway to the system; its own IP address, and send information based on what it automatically found. The fax machine may also host a server, e.g., an email style server, that receives the information, and whose address it gives out. This automatically causes the message to be sent by e-mail directly from the sending fax machine 100 to the receiving fax machine 120. For example, the fax document that has been scanned (or is being scanned) in memory may be converted into an Adobe PDF and automatically e-mailed directly to the fax machine 120. The receiving fax machine may receive this email and automatically print the attachment to simulate the operation of a conventional fax machine. The receiving fax machine may also send a signal that a fax has been received, e.g, by sending an email or text message to an operator.

After sending the message by e-mail at 230, the sending fax machine either requests, over the fax channel, an indication of whether the message has been received; or waits for an acknowledgement that the fax has been received. The receipt confirmation is shown as being sent at 240.

A positive confirmation may result in the termination of the communication, while a negative confirmation may cause a retry, or may cause the message to be sent by fax.

This embodiment requires the analog channel to be kept open over the phone lines for the whole time that the fax is being transmitted over the network lines. However, this time is relatively short compared to the time necessary for sending a conventional analog fax. Another embodiment may end the communication after the fax is sent, and reestablish the communication later to obtain confirmation.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, while the above describes certain kinds of operation over the internet, any other way of interacting via a shared network can be similarly done in this way. Another embodiment may operate over a wholly internet and/or wireless system, using fax over voice over IP as the “digital” part, and digital document over IP with the handshaking controlled over the telephone based system.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A digital fax machine, comprising:
a controller, communicating with a telephone connection and a network connection, and receiving information indicative of a scanned document, and said controller carrying out a communication over a telephone line to establish a facsimile communication, to receive an address indicative of network communication over said telephone line and to send automatically said information indicative of said scanned document as a digital file over said network connection to a destination addressed by said address indicative of network communication.

2. A machine as in claim 1, wherein said controller also sends an address indicative of network communication over the phone line, based on a request received over the phone line.

3. A machine as in claim 1, wherein said controller receives a confirmation that said information indicative of said scanned document has been received.

4. A machine as in claim 3, wherein said controller resends information over the phone line when said confirmation is not received.

5. A machine as in claim 1, wherein said address is an email address.

6. A digital fax machine, comprising:
a controller, communicating with a telephone connection and a network connection, said controller storing an address indicative of network based communication, and said controller carrying out a communication over a telephone line to establish a facsimile communication, to send said address indicative of network communication over said telephone line and to automatically receive, over a communication received via said address, information indicative of a scanned document as a digital file over said network addressed by said address indicative of network communication.

7. A machine as in claim 6, wherein said controller also receives information indicative of a scanned document, receives an address indicative of network communication over said telephone line and sends automatically said information indicative of said scanned document as a digital file over said network connection to a destination addressed by said address indicative of network communication.

8. A machine as in claim 7, wherein said controller receives a confirmation that said information indicative of said scanned document has been received.

9. A machine as in claim 8, wherein said controller resends information over the phone line when said confirmation is not received.

10. A machine as in claim 6, wherein said address is an email address.

11. A method comprising:
carrying out fax handshaking using analog tones over a telephone lines;
as part of said fax handshaking, sending an address indicative of network based communication using said analog tones;
receiving information indicative of a scanned document, at an address that is based on said sent address, over a network based connection.

12. A method as in claim 11, further comprising sending a confirmation that said information indicative of said scanned document has been received.

13. A method as in claim 12, further comprising receiving said information over said phone line when said information is not received.

14. A method as in claim 11, further comprising, as part of said fax handshaking, receiving an address indicative of network based communication using said analog tones, and sending information indicative of a scanned document, to an address that is based on said sent address, over the network based connection.
